(19) United States
(12) Patent Application Publication
(10) Pub. No.: US 2016/0259534 A1
(43) Pub. Date: Sep. 8, 2016

(54) VISUAL PROCESS CONFIGURATION INTERFACE FOR INTEGRATED PROGRAMMING INTERFACE ACTIONS

(71) Applicant: Microsoft Technology Licensing, LLC, Redmond, WA (US)

(72) Inventors: Brandon Simons, Kirkland, WA (US); Shashi Ranjan, Redmond, WA (US); Keran Zheng, Redmond, WA (US)

(21) Appl. No.: 14/737,688

(22) Filed: Jun. 12, 2015

Related U.S. Application Data
(60) Provisional application No. 62/128,659, filed on Mar. 5, 2015.

(51) Int. Cl. G06F 3/0484; G06F 3/0482

(52) U.S. Cl. CPC G06F 3/04847; G06F 3/0482

(57) ABSTRACT

A computing system comprises, in one example, a display system configured to generate user interface displays, a process configuration system configured to define a process action that targets at least one programming interface and to identify a set of parameters for the programming interface, and a display system controller configured to control the display system to generate a process action configuration user interface display with user input mechanisms that prompt the user based on the set of parameters, and to detect a user interaction with the user input mechanisms that defines one or more values for the set of parameters. The process configuration system defines the process action based on the one or more values.

### CROSS-REFERENCE TO RELATED APPLICATION

The present application is based on and claims the benefit of U.S. provisional patent application Ser. No. 62/128,659, filed Mar. 5, 2015, the content of which is hereby incorporated by reference in its entirety.

### BACKGROUND

Computing systems are currently in wide use. As one example, a computing system stores data as entities or other data records, and commonly includes process functionality that facilitates performing various processes or tasks on the data. Users log into or otherwise access the computing system in order to perform the processes and tasks. The data can include user data as well as entities or records that are used to describe various aspects of the computing system.

These types of computing systems are also often sold as a base system that is then customized or further developed for deployment in a particular user's organization. Even after fully deployed and operational at a user's organization, the user may wish to perform even more customizations or enhancements on the system, for their particular use. For example, a user may desire to define a specific workflow that can execute actions against the organizational data.

Currently, in order to customize such a system, the user often needs to employ a variety of different people, with varying knowledge, in order to make the customizations or enhancements. Some such people include designers that design the various customizations. Other people include developers that have detailed knowledge about the inner working of the computing system, who actually implement the customizations by writing application code that execute various actions within the computing system. For example, an operating environment within the computing system is provided with programming interfaces, such as a set of application programming interfaces (APIs), that allows the developer to write applications consistent with the operating environment using a software development kit (SDK). However, the developer must understand the operating environment and coding language to develop workflows or other processes. Thus, making the customizations to the system can be error prone and time consuming, and it can also be relatively costly.

The discussion above is merely provided for general background information and is not intended to be used as an aid in determining the scope of the claimed subject matter.

### SUMMARY

A computing system comprises, in one example, a display system configured to generate user interface displays, a process configuration system configured to define a process action that targets at least one programming interface and to identify a set of parameters for the programming interface, and a display system controller configured to control the display system to generate a process action configuration user interface display with user input mechanisms that prompt the user based on the set of parameters, and to detect a user interaction with the user input mechanisms that defines one or more values for the set of parameters. The process configuration system defines the process action based on the one or more values.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system.

FIG. 2 illustrates one example of a method for creating a process action.

FIGS. 2-1, 2-2, and 2-3 illustrate example user interface displays.

FIG. 3 illustrates one example of a method for creating a process that calls a process action.

FIGS. 3-1 and 3-2 illustrate example user interface displays.

FIG. 4 illustrates one example of a method for executing a workflow within a computing system.

FIG. 5 is a block diagram showing one example of the computing system illustrated in FIG. 1, deployed a cloud computing architecture.

FIGS. 6-8 show various examples of mobile devices that can be used with the computing system shown in FIG. 1.

FIG. 9 is a block diagram of one example computing environment.

### DETAILED DESCRIPTION

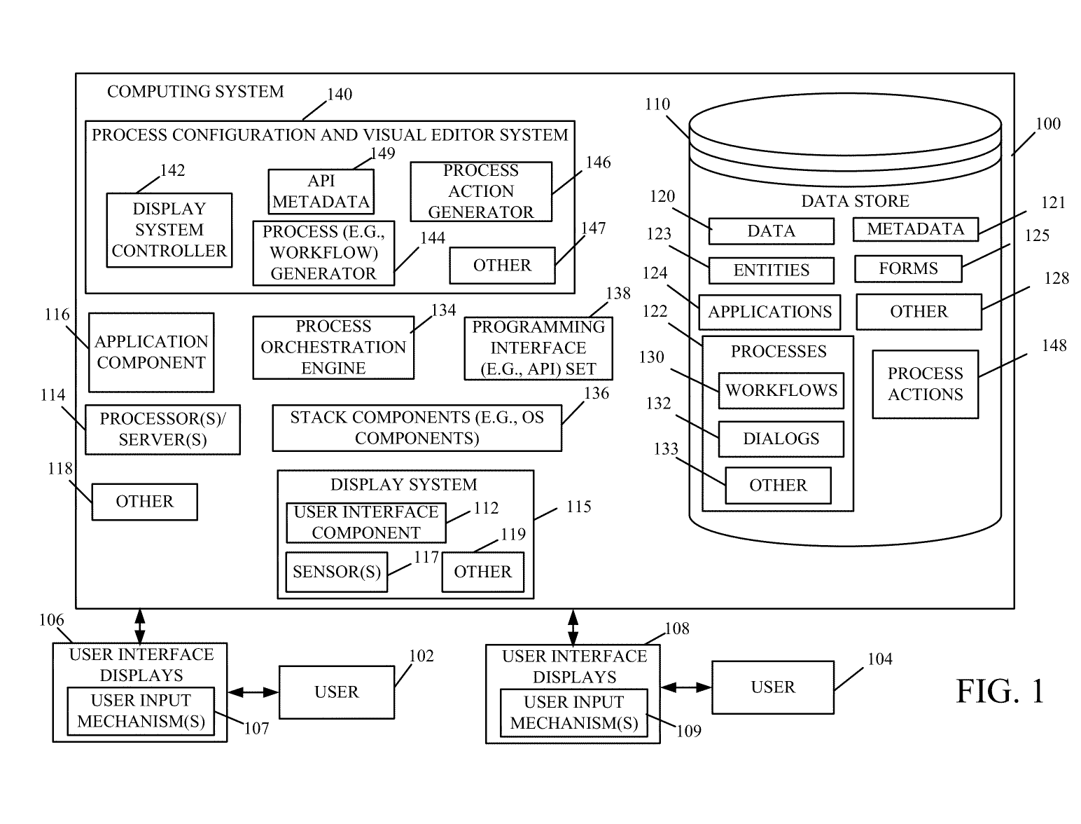

FIG. 1 is a block diagram of one example of a computing system 100 that is accessible by one or more users through one or more user interface displays. Computing system 100 is shown generating user interface displays 106 and 108 with user input mechanisms 107 and 109 for interaction by users 102 and 104, respectively. In FIG. 1, two users are illustrated interacting with computing system 100, for sake of illustration. However, in other examples, any number of users may interact with computing system 100.

Each of users 102 and 104 can access computing system 100 locally or remotely. In one example, one or more of users 102 and 104 use a respective client device that communicates with computing system 100 over a wide area network, such as the Internet.

Users 102 and 104 illustratively interacts with user input mechanisms 107 and 109 in order to control and manipulate various parts of computing system 100. For instance, users 102 and 104 can access data in a data store 110. User data access can include, but is not limited to, read access, write access, and/or update access to the data. Updating data can include modifying and/or deleting data in data store 110.

In the example shown in FIG. 1, computing system 100 illustratively includes processor(s) and/or server(s) 114, a display system 115 (which, itself, includes a user interface component 112 and one or more sensors 117, and it can include other items 119 as well), an application component 116, and a process configuration and visual editor system 140. User interface component 112, either by itself or under the control of other items in system 100, generates user interface displays 106, 108 for users 102, 104. In one example, one or more of user interface displays include user input mechanisms that receive inputs from the user for manipulating application component 116 or for manipulating and interacting with other items in computing system 100.

Sensor(s) 117 are configured to detect inputs to display system 115. In one example, system 140 also includes sensors configured to detect inputs to system 140. Computing system 100 can include other items 118 as well.

In one example, processor(s) and/or server(s) 114 comprises a computer processor with associated memory and timing circuitry (not shown). The computer processor is a functional part of system 100 and is activated by, and facilitates the functionality of, other systems, components and items in computing system 100.

User input mechanisms 107, 109 sense physical activities, for example by generating user interface displays 106, 108 that are used to sense user interaction with computing system 100. The user interface displays can include user input mechanisms that sense user input in a wide variety of different ways, such as point and click devices (e.g., a computer mouse or track ball), a keyboard (either virtual or hardware), and/or a keypad. Where the display device used to display the user interface displays is a touch sensitive display, the inputs can be provided as touch gestures. Similarly, the user inputs can illustratively be provided by voice inputs or other natural user interface input mechanisms as well.

Data store 110, in one embodiment, stores data 120 and metadata 121. The data and metadata can define processes 122, entities 123, applications 124, and forms 125 that are implemented by application component 116 for users of computing system 100 to perform processes and tasks. The information can include other data 128 as well that can be used by application component 116 or other items in computing system 100. Entities 123, in one embodiment, describes entities within or otherwise used by system 100. Examples of entities 123 include, but are not limited to, accounts, documents, emails, people, customers, opportunities, etc.

FIG. 1 shows a variety of different blocks. It will be noted that the blocks can be consolidated so that more functionality is performed by each block, or they can be divided so that the functionality is further distributed. It should also be noted that data store 110 can be any of a wide variety of different types of data stores. Further, the data in the data store can be stored in multiple additional data stores as well. Also, the data stores can be local to the environments, agents, modules, and/or components that access them, or they can be remote therefrom and accessible by those environments, agents, modules, and/or components. Similarly, some can be local while others are remote.

Computing system 100 can be any type of system accessed by users 102 and 104. In one example, but not by limitation, computing system 100 can comprise an electronic mail (email) system, a collaboration system, a document sharing system, a scheduling system, and/or an enterprise system. In one example, computing system 100 comprises a business system, such as an enterprise resource planning (ERP) system, a customer resource management (CRM) system, a line-of-business system, or another business system. As such, applications 124 can be any suitable applications that may be executed by system 100 in order to perform one or more functions for which system 100 is deployed.

Application component 116 accesses the information in data store 110 in implementing the programs, processes, or other operations performed by the application component 116. For instance, application component 116, in one example, runs applications 124, which can include processes 122. Processes 122 include, for example, workflows 130, dialogs 132, and/or other types of processes 133 that operate upon data entities 123 as well as other data 128 in order to perform operations within system 100.

Workflows 130 enable users to perform various tasks and activities relative to entities 123 within computing system 100. By way of example, an entity 123 can comprise an opportunity within an organization. A corresponding workflow 130 includes a set of steps or activities that are implemented relative to the opportunity, such as tracking the opportunity, escalating a case corresponding to the opportunity, or requesting an approval process. For instance, if there is an opportunity to make a sale of products or services to another organization, a workflow within the system allows users to enter information that may be helpful in converting that opportunity into an actual sale. Similarly, many other types of workflows can be performed as well. For instance, some workflows allow users to prepare a quote for a potential customer. These, of course, are merely examples of a wide variety of different types of processes 122 that can be performed within a computing system.

In one example, computing system 100 includes a process orchestration engine 134 that accesses and executes stored processes 122, such as workflows 130 and/or dialogs 132. For instance, process orchestration engine 134 can detect a trigger condition, relative to an invoice entity within computing system 100, and initiate a corresponding workflow 130 for that invoice entity. Engine 134 then begins to perform the workflow tasks on the invoice entity.

Computing system 100 includes stack components 136 and a corresponding programming interface set 138. By way of example, stack components 136 include components of the operation environment of computing system 100. Programming interface set 138 facilitates building applications 124, or other software or program components, and executing the requisite functionality on stack components 136, for example. Each programming interface in set 138 expresses a software component in terms of its operations, inputs, outputs, and underlying data types. A programming interface, such as an application programming interface (“API”), specifies a set of functions or routines that accomplish a specific task and/or are allowed to interact with the software component (e.g., such as an application). Embodiments are described herein in the context of APIs for the sake of illustration, but not by limitation. Other types of programming interfaces can be utilized.

To write an application executing various processes against stack components (or other components), current systems require a developer with extensive knowledge of the operating environment and coding language to write application code to execute against the APIs. Thus, creating or modifying processes within these system is expensive as it requires a developer to design, develop, text, and deploy code that was specific to an action that the required by the process.

In the illustrated embodiment, process configuration and visual editor system 140 enables non-developer users (e.g., users 102 and/or 104 in FIG. 1) to create an action within a process (referred to herein as a process action) that interacts directly with API(s) of API set 138. In other words, the process action targets or calls one or more APIs directly from the executing process. As mentioned above, examples of processes 122 within computing system 100 include workflows 130 and/or dialogs 132. For the sake of illustration, but not by limitation, the present discussion will continue with respect to defining a workflow. However, one skilled in the art understands that these concepts can be applied to other types of processes, including but not limited to, dialogs.

Using system 140, the non-developer user can generate and add steps to a workflow (or other process) that are mapped to the actions that target the APIs. As shown in FIG. 1, system 140 includes a display system controller 142 configured to control display system 115 to generate user interface displays, using user interface component 112, with user input mechanisms that receive inputs from user 102. System 140 also includes a process (e.g., workflow) generator 144 that enables user 102 to create or modify a workflow (or other process) and a process action generator 146 that enables the user 102 to generate a process action. System 140 can include other items 147 as well.

In one embodiment, in creating a process action a user packages a set of steps that are called from a workflow and target one or more APIs for execution within computing system 100. In one example, a process action comprises a collection of SDK messages that are packaged into a library and can be called from a workflow. In this way, the process action can enrich workflows to leverage an SDK's entire message set. Further, the packaged set of SDK messages is callable through any of a plurality of workflows. In this way, the process action is reusable across workflows, and can be updated independent from the workflows that call the process action.

For sake of illustration, one example of a process action is an “action for approval” that includes messages for targeting APIs during an approval process. This process action can be called from a first workflow that is triggered when an opportunity entity is updated as well as from a second workflow that is triggered when a project entity is completed. This process action can be updated using system 140 without having to directly update the first and second workflows. A collection of stored process actions 148 in data store 110 can be provided to user 102 as a library for subsequent workflow generation and modification.

System 140 also includes API metadata 149 for API set 138. API metadata 149 describes the various inputs, outputs, data types, and/or operations required or performed by a given API. System 140 uses this information in generating corresponding user interfaces (e.g., user interfaces 106) to the user (e.g., user 102).

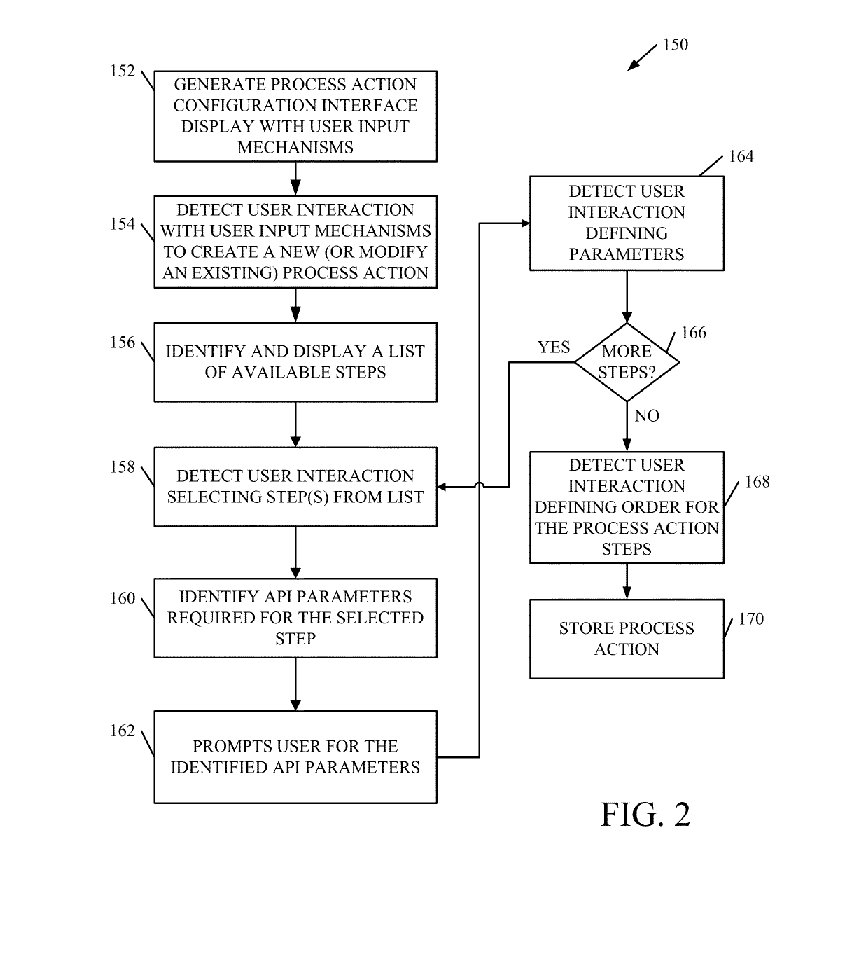

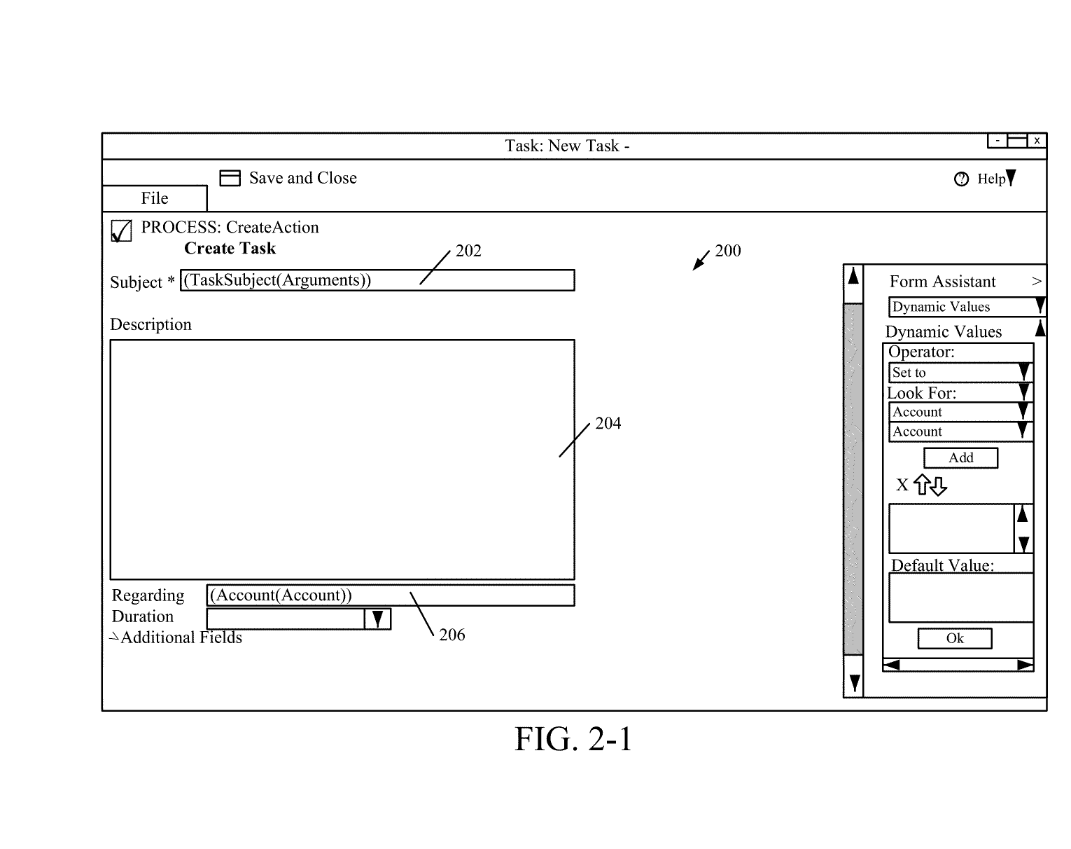

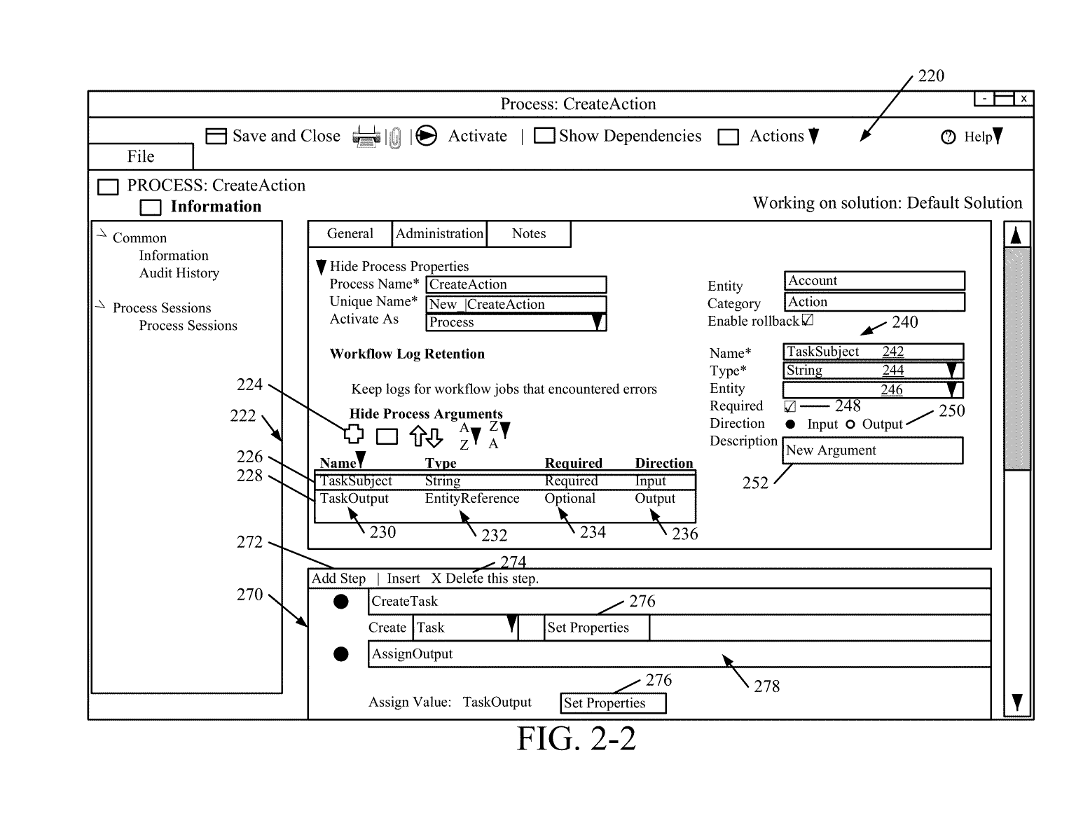

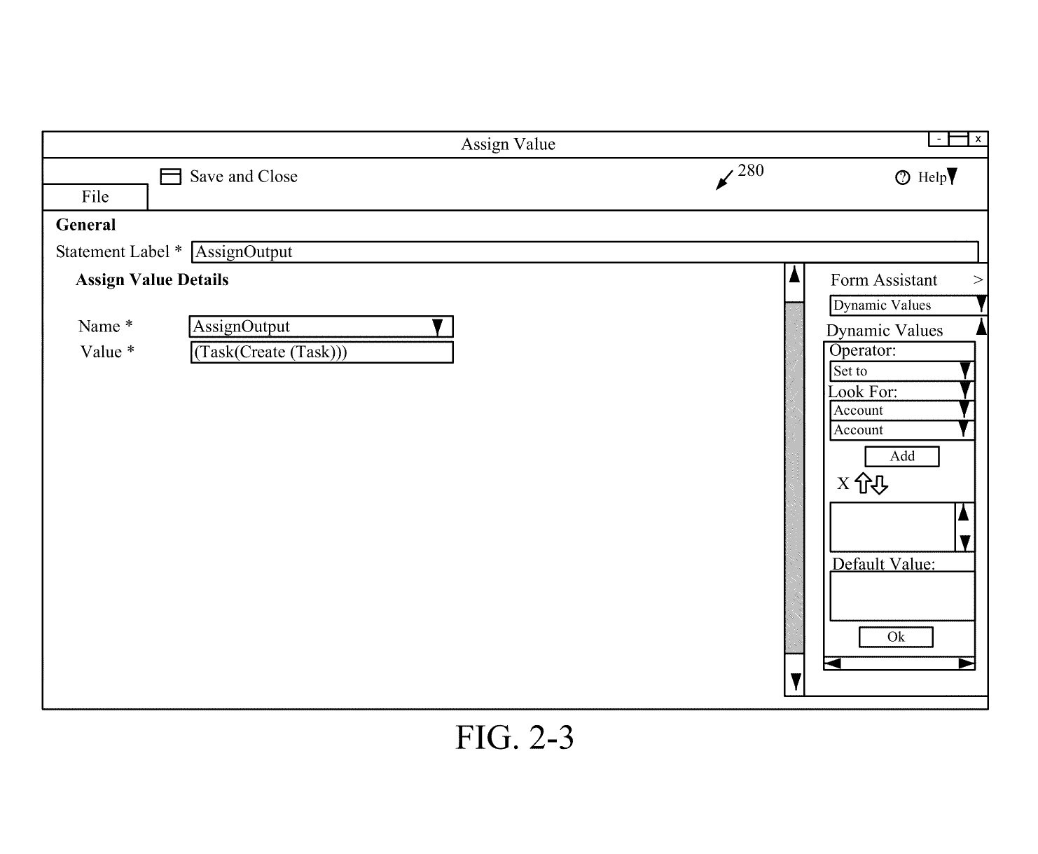

FIG. 2 illustrates one example of a method 150 for creating a process action. For sake of illustration, but not by limitation, method 150 will be described in the context of computing system 100 shown in FIG. 1.

At step 152, display system controller 142 controls display system 115 to generate and display a process action configuration interface display with user input mechanism. FIGS. 2-1, 2-2, and 2-3 are screenshots of example process action configuration user interface displays 200, 220, and 240. For sake of illustration, user interface displays 200, 220, and 240 will be described in conjunction with one another in the context of method 150.

At step 154, a user input is detected through the process action configuration interface display indicating a user desire to create a new process action. This can include receiving an identifier from the user, such as a process action name (i.e., “action for approval” in the above example). Alternatively, the user input can be received to modify an existing, stored process action 148. With respect to the example in FIG. 2-1, a user input is received in a user input mechanism 202 (illustratively a text entry field) that provides a process action name for a new process action being created. Also, a user input mechanism 204 (illustratively a text entry field) is provided to receive a description for the process action. The user interface display 200 can also include a user input mechanism 206 (illustratively a text entry field) for identifying an entity related to or otherwise associated with the process action.

At step 156, process action generator 146 identifies a set of available steps that can be added to the process action. Each available step comprises an event or activity relative to an API in API set 138. For example, the steps can correspond to API messages provided by an SDK. Some examples of messages include “qualified lead”, “change status”, “create e-mail”, to name a few. Each step targets one or more of the APIs in API set 138 and has a set of parameters or properties required for calling the API(s). These parameters are defined within API metadata 149. In one example, display system 115 can be controlled by display system controller 142 to display the available steps in a list.

At step 158, a user interaction is detect that selects or otherwise identifies at least one step that is to be included in the process action. This can include selecting one of the steps displayed in the list at step 156.

At step 160, process action generator 146 accesses API metadata 149 to identify the corresponding parameters for the one or more APIs that are targeted by the selected step. These parameters include, but are not limited to, a set of input parameters to be passed to the API, a set of return parameters that are returned by the API, and a value type of the parameters. Also, for each parameter, API metadata 149 can define a range of allowable values for the parameter. As used herein, a value can include numerical value(s) and/or non-numerical value(s) (e.g., a string, a Boolean value, or other non-numerical values).

At step 162, process action generator 146 uses display system controller 142 to control display system 1115 in generating an API parameter interface display that prompts the user for the identified parameters. For example, the API parameter interface display can identify what input parameters are required by the API, a type of the parameter and an acceptable range of values for the parameter. The API parameter interface display can include input fields (e.g., a text entry box or control, etc.) that receive user input defining the parameters.

At step 164, display system 115 detects user interaction with the user input mechanism of the API parameter interface display that defines the API parameters. In one example, system 140 constrains the user input based on the API metadata. For instance, display system controller 142 can control display system 115 to display a warning message (or other indicator) and/or reject the user input if the user input parameter is outside an allowable range of values for the API parameter.

At block 166, the method determines whether there are any additional steps to be added to the process action. For example, the user can add another step to the process action (e.g., by selecting the step from the list at step 158) upon which method 150 repeats method steps 160, 162, and 164 for each additional process action step.

At step 168, a user interaction can be detected that defines an order for the process action steps. For example, the user can provide drag and drop inputs to visually arrange the process actions steps to define the execution order.

Once all process action steps have been added by the user, the process proceeds to step 170 in which the process action is stored, for example into the set of process actions 148 in data store 110. In one example, the process action is stored at step 170 as a library of actions that can be called by a particular process, such as a workflow 130 or a dialog 132. In this manner, process actions 148 comprise a collection of process actions that can be updated, deleted, and assigned to various processes 122. Also, a stored process action 148 can be accessed by users to update or modify the process action and/or to assign the process action to a plurality of different processes 122.

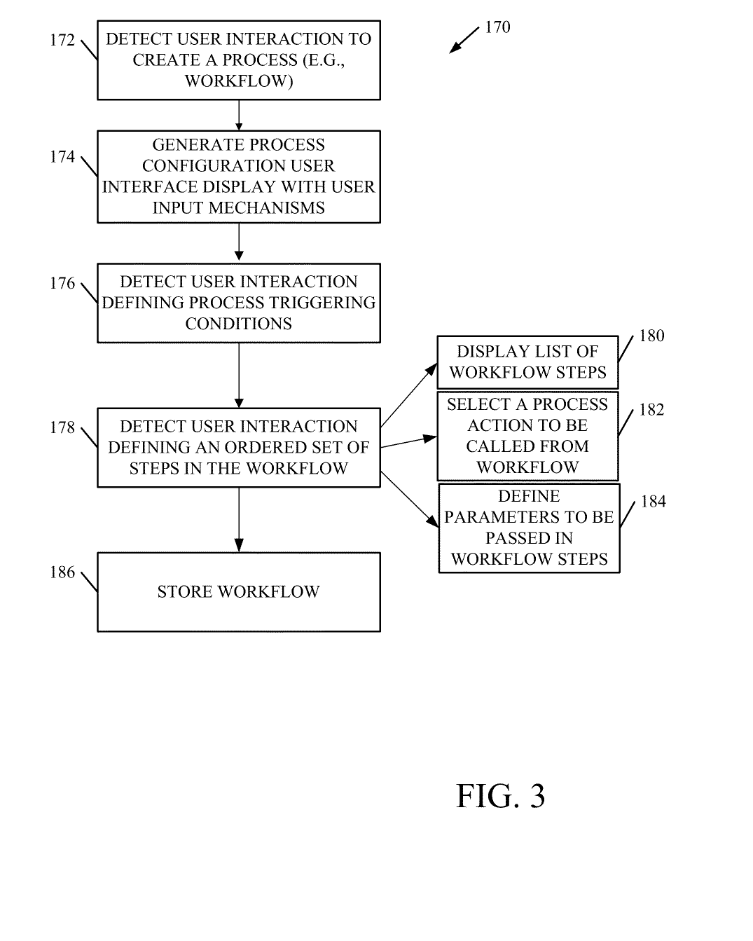

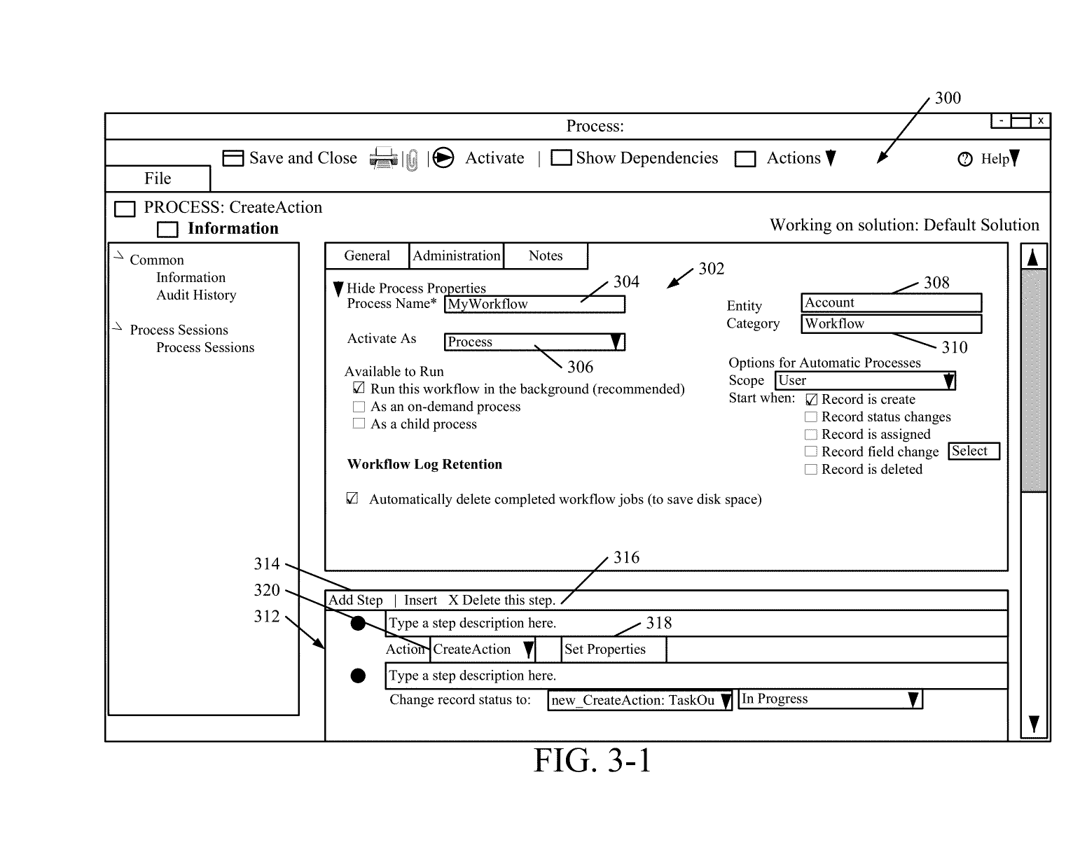

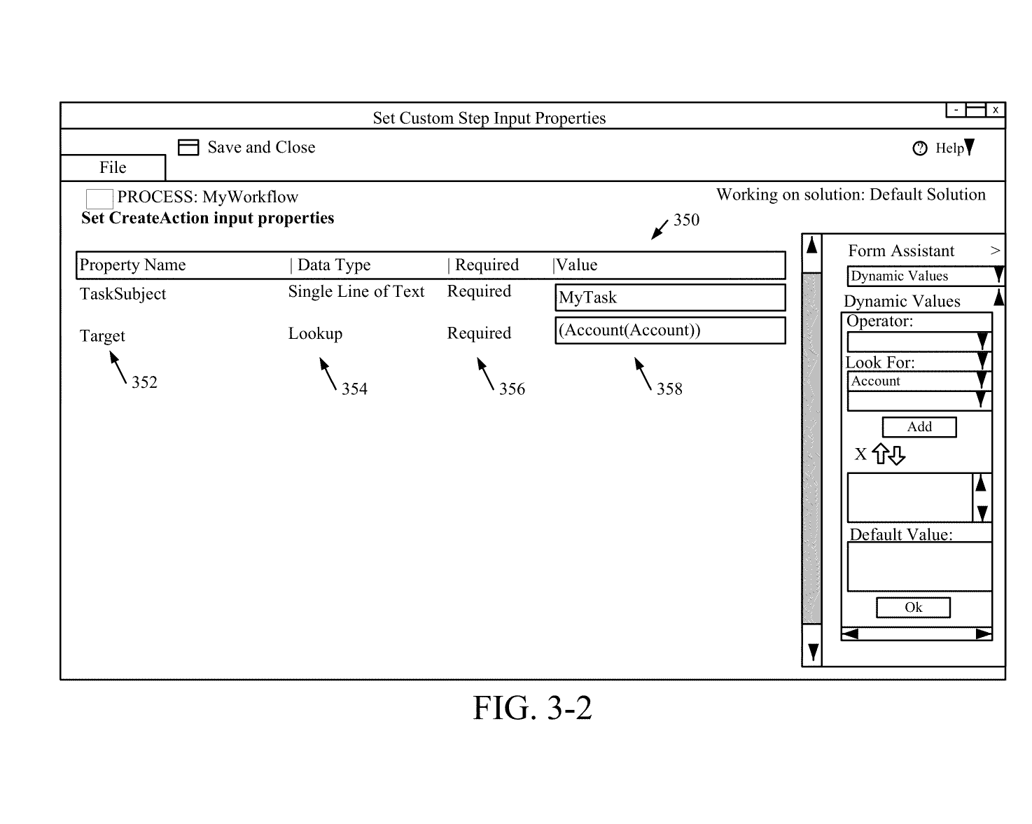

FIGS. 2-2 and 2-3 illustrate example process action configuration user interface displays 220 and 280 that can be displayed for steps 156-170. As shown in FIG. 2-2, process action configuration user interface display 220 includes user input mechanisms 222 for defining arguments for the process action. A user actuatable button 224 (or other display element) allows the user to define a new process argument. In the illustrated example, a process action input argument 226 defines the input or subject of the process action and a process action output argument 228 defines the output of the process action. Each argument is represented by an entry in list 230 that defines a type 232 of the argument, whether the argument is required 234 for the process action, and a direction 236 (e.g., input or output) for the argument.

Process action configuration user interface display 220 also includes user input mechanisms 240 to define the process argument selected in list 230. User input mechanisms 240 includes a user input mechanism 242 to define a name for the argument, a user input mechanism 244 to define a type for the argument, a user input mechanism 246 to define an associated entity for the argument, a user input mechanism 248 to define whether the argument is required, a user input mechanism 250 to define a direction (e.g., input or output) for the argument, and a user input mechanism 252 to provide a description of the argument. Illustratively, user input mechanisms 242, 244, 246, and 252 are text entry fields, user input mechanism 248 is a checkbox, and user input mechanism 250 is a radio button. Of course, other types of input mechanisms can be utilized.

Process action configuration user interface display 220 also includes user input mechanisms 270 for defining steps within the process action. User input mechanisms 270 include a user actuatable button 272 (or other display element) for adding steps to the process action and a user actuatable button 274 (or other display element) for deleting steps from the process action. For each step, the user can set the properties using a user actuatable button 276 (or other display element). In response to actuating button 276, process action configuration user interface display 220 provides user input mechanisms for the user to define or set the properties of each step. One example of this is discussed above with respect to steps 160-164. Process action configuration interface display 280 shown in FIG. 2-3 provides a user interface for the user to assign the process action to its output parameter 278.

This architecture for providing process actions can simplify management of the processes 122 within computing system 100 and provides an easy to consume experience for non-developers that can be less error prone than coding and can decrease design time.

FIG. 3 illustrates one example of a method 170 for creating a process that calls a process action, such as the process action created in method 150 discussed above. For sake of illustration, but not by limitation, method 170 will be described in the context of computing system 100 shown in FIG. 1. Further, method 170 will be described with respect to creating a workflow, but one skilled in the art will appreciate that other types of processes can be created as well.

At step 172, a user interaction is detected that indicates a user desire to create a process within computing system 100. For example, the user provides a user request input to create a new workflow or to modify an existing workflow 130 to be implemented by a given organization.

At step 174, display system controller 142 controls display system 115 to generate a process configuration user interface display with user input mechanisms. At step 176, a user interaction with the user input mechanisms is detected that defines one or more triggering conditions. For example, the user can input a set of trigger criteria that trigger the workflow.

At step 178, a user interaction is detected that defines steps in the workflow. For example, a user input can define an ordered set of steps in the workflow, where the steps are executed at runtime in accordance with a defined order.

In one example, a user interface display is generated with user input mechanism that detect user inputs. The user inputs can define one or more entities that are included in a step in the workflow and specify fields of the entity that are affected by the step. In one example, at step 180, a list of available workflow steps is displayed from which the user can select a desired set of steps that are arranged by the user in a desired workflow order.

At step 182, the user can select a process action to be called from the workflow. For example, system 140 displays process actions 148 from data store 110 for selection by the user. By selecting a process action at step 182, the user maps a step in the workflow to one or more APIs that are targeted by predefined steps in the process action.

At step 184, a user input defines parameters that are passed to the steps within the workflow. For example, user inputs are detected that define how input and output parameters are piped between different workflow steps within the workflow. In one particular example, at step 184, the user defines what input parameters are provided to the process action selected at step 182, and what output parameters are returned from that process action and called back into the workflow so that it can be consumed by the other workflow steps, such as other process actions, in the workflow.

At step 186, the workflow is stored in data store 110. For example, processor generator 144 can save the workflow for use in computing system 100, such as by placing it in data store 110 so that it can be accessed by applications 124 or other components or items in computing system 100.

FIGS. 3-1 and 3-2 illustrate example process configuration user interface displays 300 and 350 that can be displayed in method 170. Process configuration user interface display 300 includes user input mechanisms 302 to define properties for a new or existing workflow or other process. User input mechanisms 302 include a user input mechanism 304 (illustratively a text entry field) for providing a process name, a user input mechanism 306 (illustratively a drop down box) for defining how the process is to be activated, and user input mechanisms 308 and 310 (illustratively a text entry fields) for defining an entity and category, respectively, for the process.

Process configuration user interface display 300 also includes user input mechanisms 312 for defining steps within the process. User input mechanisms 312 include a user actuatable button 314 (or other display element) for adding steps to the process and a user actuatable button 316 (or other display element) for deleting steps from the process. For each step, the user can set the properties using a user actuatable button 318 (or other display element). In response to actuating button 318, process configuration user interface display 300 provides user input mechanism for the user to define or set the properties of each step. One example of this is discussed above with respect to step 178.

For instance, using input mechanism 320 (illustratively a drop down box), a user selects a predefined process action (e.g., a “CreateAction” process action defined using the user interface display of FIG. 2-2) and then actuates button 318 to set the properties for that step in the process. FIG. 3-2 shows one example of a process configuration user interface display 350 that includes user input mechanisms for defining input properties to a process action that is called from the process defining in user interface display 300.

In the example of FIG. 3-2, process configuration user interface display 350 displays a list 352 of input properties for the process action. For each property in list 352, display 350 shows a data type field 354, a required field 356, and a value field 358 which is configured to receive a user input that devices a value for the corresponding property.

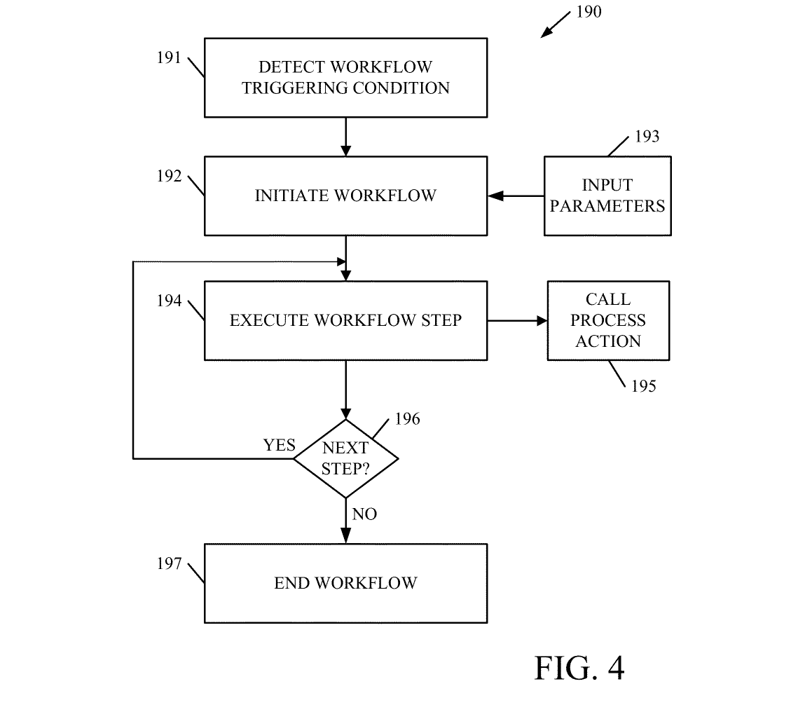

FIG. 4 illustrates one example of a method 190 for executing a workflow within computing system 100. For sake of illustration, but not by limitation, method 190 will be described in the context of computing system 100 shown in FIG. 1.

At step 191, a workflow triggering condition is detected. In one example, the triggering condition can occur in response to a user input that initiates the workflow. Alternatively, or in addition, triggering condition is automatically detected at step 191 by process orchestration engine 134. The triggering condition can be, in one example, a particular event that occurs within computing system 100 from application component 116 executing an application 124.

At step 192, the workflow is initiated. For example, step 192 can take input parameters 193 that are passed to a first or next step in the workflow. The workflow step is executed at step 194. If the workflow step comprises a process action, the process action is called at step 195. The input parameters are passed to the process action as a set of inputs and a set of output parameters are returned to the workflow.

At step 196, the method 190 determines whether there is any more steps in the workflow. If so, method 190 returns to step 194 in which the returned parameters are provided as input parameters to the next step. Once all steps in the workflow are completed, the workflow ends at step 197.

It can thus be seen that the present description provides significant technical advantages. As mentioned above, in a typical computing system development scenario, a developer must understand the operating environment and coding language to develop workflows or other processes. In the present description, a process configuration architecture deploys a visual editor for developers, as well as non-developers, to create process actions. This architecture can simplify management of computing system processes and provide an easy to consume user experience that can be less error prone than developer coding and can decrease design time. Further, the process actions are reusable across multiple processes which reduces the time and computing expense needed to generate the multiple processes.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

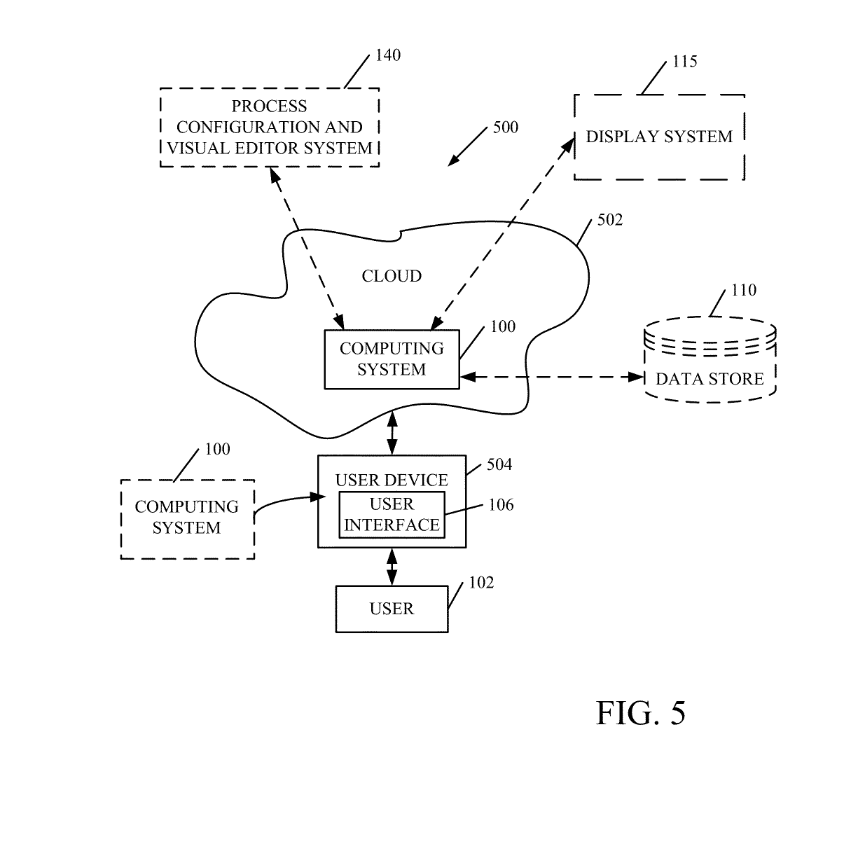

FIG. 5 is a block diagram of a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of computing system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 5, some items are similar to those shown in FIG. 1 and they are similarly numbered. FIG. 5 specifically shows that some or all components of computing system 100 are located in cloud 502 (which can be public, private, or a combination where portions are public while others are private). Therefore, user 102 uses a user device 504 to access those components through cloud 502.

FIG. 5 also depicts another embodiment of a cloud architecture. FIG. 5 shows that it is also contemplated that some elements of computing system 100 are disposed in cloud 502 while others are not. By way of example, data store 110 can be disposed outside of cloud 502, and accessed through cloud 502. In another example, display system 115 can be disposed outside of cloud 502, and accessed through cloud 502. In another example, process configuration and visual editor system 140 can be disposed outside of cloud 502, and accessed through cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. FIG. 5 also shows that system 100, or parts of it, can be deployed on user device 504. All of these architectures are contemplated herein.

It will also be noted that computing system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

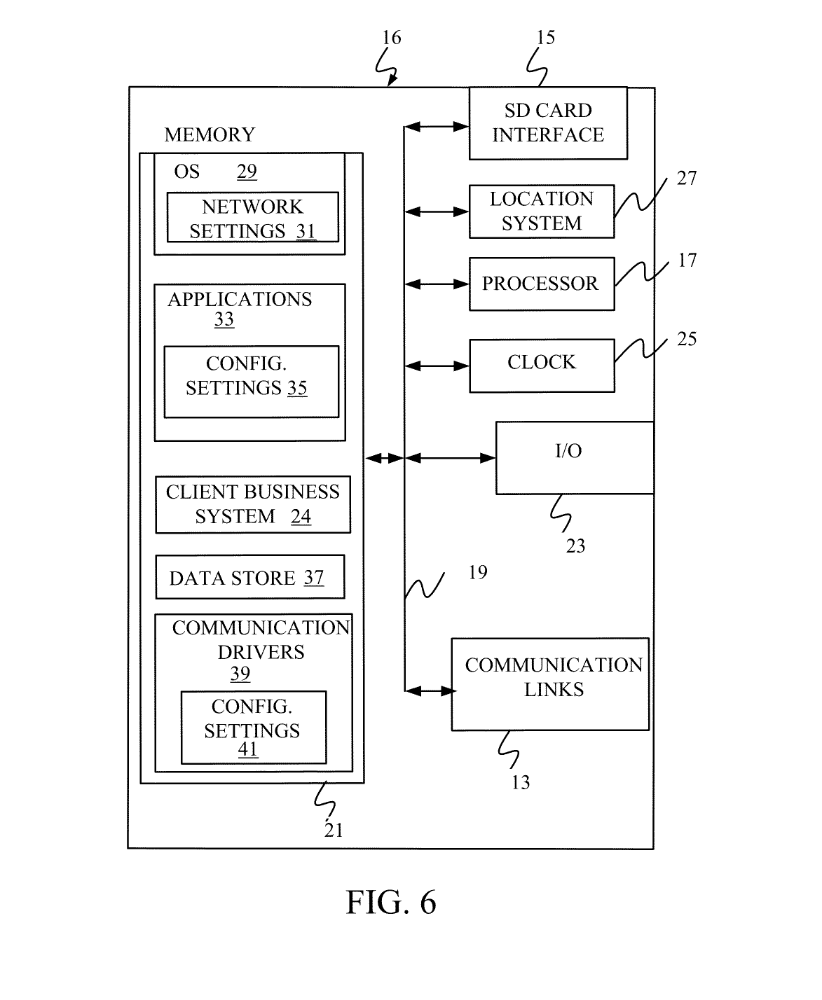

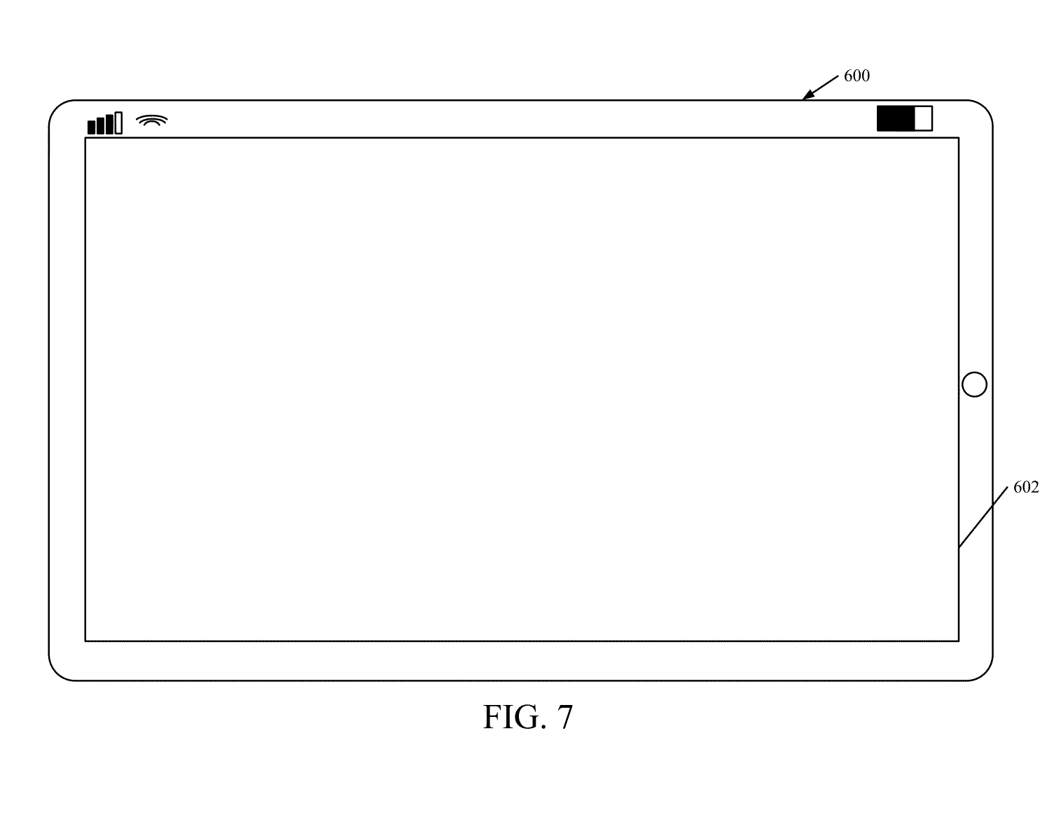

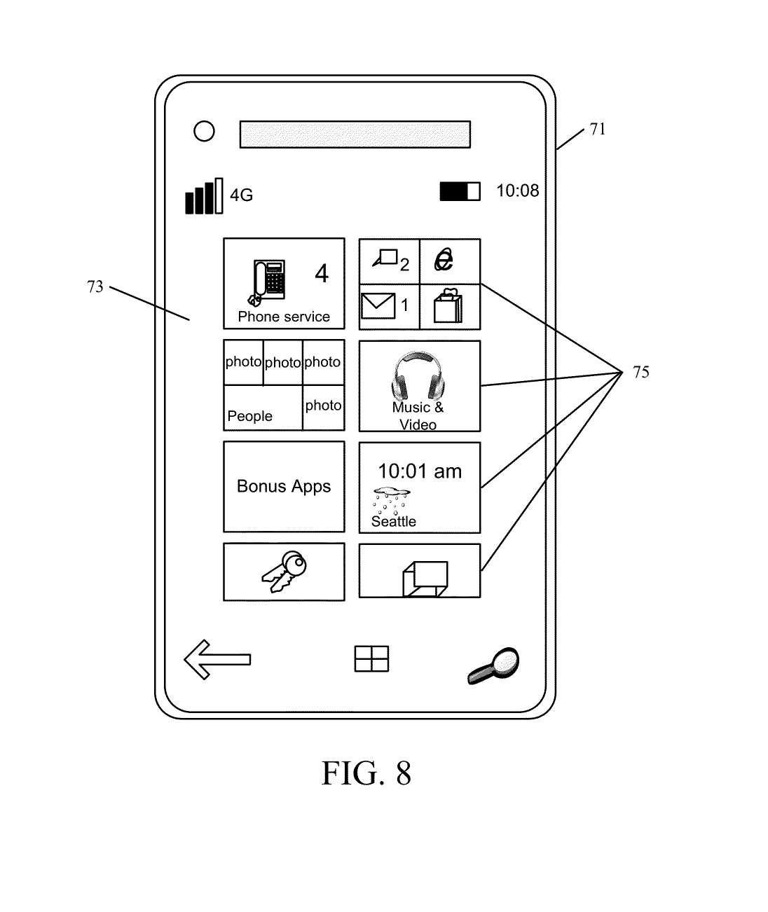

FIG. 6 is a simplified block diagram of one illustrative embodiment of a handheld or mobile computing device that can be used as a user's or client's hand held device 16, in which the present system (or parts of it) can be deployed. FIGS. 7-8 are examples of handheld or mobile devices.

FIG. 6 provides a general block diagram of the components of a client device 16 that can run components of computing system 100 or that interacts with computing system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. The items in data store 110, for example, can reside in memory 21. Similarly, device 16 can have a client business system 24 which can run various business applications. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one embodiment in which device 16 is a tablet computer 600. In FIG. 7, computer 600 is shown with user interface display displayed on the display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can be used, as well. Device 16 can be a feature phone, smart phone or mobile phone. The phone includes a set of keypads for dialing phone numbers, a display capable of displaying images including application images, icons, web pages, photographs, and video, and control buttons for selecting items shown on the display. The phone includes an antenna for receiving cellular phone signals such as General Packet Radio Service (GPRS) and 1Xrtt, and Short Message Service (SMS) signals. In some embodiments, phone also includes a Secure Digital (SD) card slot that accepts a SD card.

The mobile device can be personal digital assistant (PDA) or a multimedia player or a tablet computing device, etc. (hereinafter referred to as a PDA). The PDA can include an inductive screen that senses the position of a stylus (or other pointers, such as a user's finger) when the stylus is positioned over the screen. This allows the user to select, highlight, and move items on the screen as well as draw and write. The PDA also includes a number of user input keys or buttons which allow the user to scroll through menu options or other display options which are displayed on the display, and allow the user to change applications or select user input functions, without contacting the display. Although not shown, The PDA can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device also includes a SD card slot that accepts a SD card.

FIG. 8 shows that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

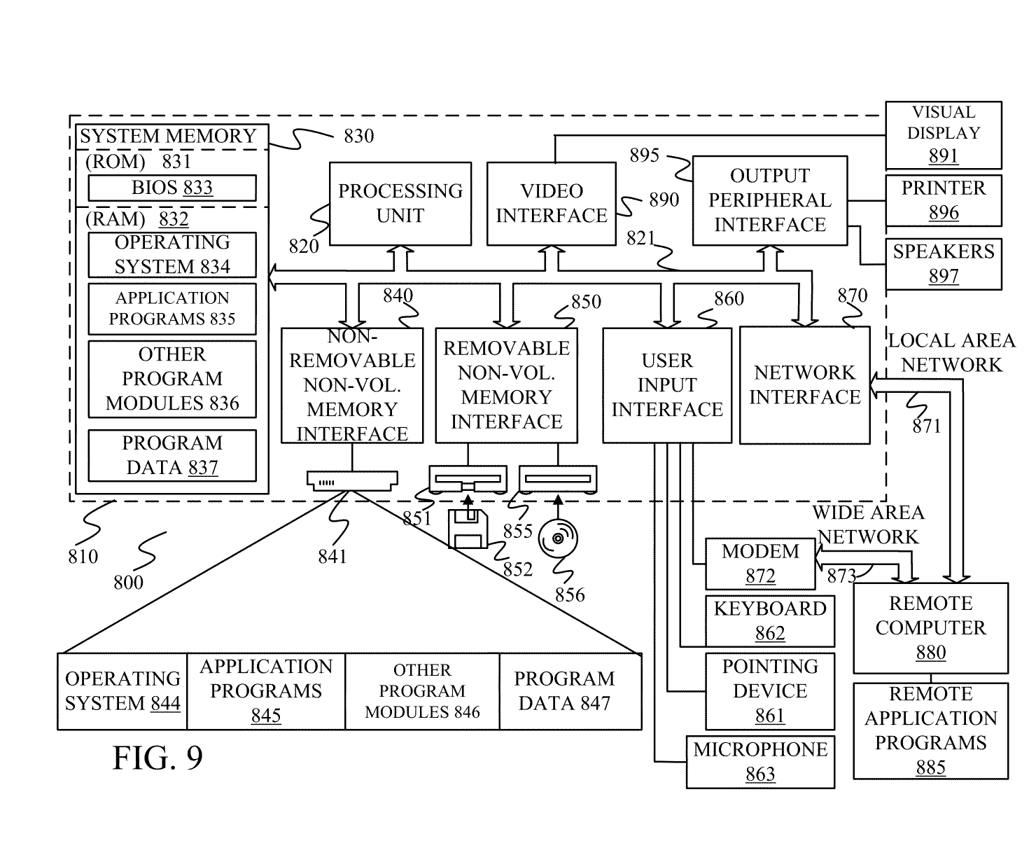

FIG. 9 is one embodiment of a computing environment in which computing system 100, or parts of it, (for example) can be deployed. With reference to FIG. 9, an exemplary system for implementing some embodiments includes a general-purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 9 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 9 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system comprising a display system configured to generate user interface displays, a process configuration system configured to define a process action that targets at least one programming interface and to identify a set of parameters for the programming interface, and a display system controller configured to control the display system to generate a process action configuration user interface display with user input mechanisms that prompt the user based on the set of parameters, and to detect a user interaction with the user input mechanisms that defines one or more values for the set of parameters. The process configuration system defines the process action based on the one or more values.

Example 2 is the computing system of any or all previous examples, and further comprising an application programming interface (API) set, wherein the process action calls at least one API in the API set.

Example 3 is the computing system of any or all previous examples, wherein the process configuration system accesses API metadata to identify the set of parameters.

Example 4 is the computing system of any or all previous examples, wherein the set of parameters comprises at least one of an input parameter that is passed to the programming interface or an output parameter that is returned from the programming interface.

Example 5 is the computing system of any or all previous examples, wherein the process configuration system is configured to identify a parameter constraint relative to the set of parameters, the parameter constraint comprising at least one of a range of allowable values for a given parameter or a value type for a given parameter.

Example 6 is the computing system of any or all previous examples, wherein the process configuration system is configured to constrain the one or more values for the set of parameters based on the parameter constraint.

Example 7 is the computing system of any or all previous examples, wherein the process configuration system detects a user interaction that defines a set of process action steps for the process action, each process action step targeting at least one programming interface.

Example 8 is the computing system of any or all previous examples, wherein, for each process action step, the process configuration system is configured to identify a parameter for the corresponding programming interface targeted by the process action step.

Example 9 is the computing system of any or all previous examples, wherein the display system controller is configured to control the display system to generate the process action configuration user interface display with user input mechanisms that prompt the user based on the identified parameter for each process action step.

Example 10 is the computing system of any or all previous examples, wherein the process configuration system is configured to generate a library that includes the set of process action steps and is callable from a process to execute the process action steps.

Example 11 is the computing system of any or all previous examples, wherein the process configuration system is configured to control the display system to generate a process generation user interface display with user input mechanisms and to detect a user interaction that defines a given process and maps the process action to at least one step in the given process.

Example 12 is the computing system of any or all previous examples, wherein the at least one step in the given process calls the process action to execute the process action steps.

Example 13 is the computing system of any or all previous examples, wherein the given process comprises at least one of a workflow or a dialog.

Example 14 is the computing system of any or all previous examples, wherein the process action is reusable across a plurality of different processes, the process configuration system being configured to detect a user interaction that defines a second process, that is different than the given process, and maps the process action to at least one step in the second process.

Example 15 is the computing system of any or all previous examples, wherein the process configuration system detects a user interaction that modifies the process action independent of the given process to which the process action is mapped.

Example 16 is the computing system of any or all previous examples, and further comprising a process orchestration engine configured to execute the given process such that the at least one step in the given process calls the programming interface.

Example 17 is a computing system comprising a display system, a display system controller configured to control the display system to generate a process generation user interface display with user input mechanisms and to detect a user interaction with the user input mechanisms that defines a set of steps for a given process and maps an application programming interface (API) action to at least one of the steps, and a process generation system configured to generate the given process with the API action.

Example 18 is the computing system of any or all previous examples, and further comprising a process action store that stores a set of process actions, each process action targeting at least one API, and wherein the display system controller controls the display system to display an indication of the set of process actions and to detect a user input that maps a given one of the process actions to the at least one step in the given process.

Example 19 is the computing system of any or all previous examples, wherein the given process action is reusable across a plurality of different processes, the process generation system being configured to generate a second process having at least one step to which the given process action is mapped.

Example 20 is a computing-implemented method comprising detecting a user interaction to define a process action that targets at least one programming interface, identifying a set of parameters for the programming interface, prompting the user for a parameter value user input based on the set of parameters, detecting a user interaction that defines at least one parameter value for the set of parameters, storing the process action with the defined parameter value, and detecting a user interaction that defines a set of process steps within a process and that maps the process action to at least one of the process steps.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other equivalent features and acts are intended to be within the scope of the claims.

What is claimed is:

1. A computing system comprising:
a display system configured to generate user interface displays;
a process configuration system configured to define a process action that targets at least one programming interface and to identify a set of parameters for the programming interface; and
a display system controller configured to control the display system to generate a process action configuration user interface display with user input mechanisms that prompt the user based on the set of parameters, and to detect a user interaction with the user input mechanisms that defines one or more values for the set of parameters, wherein the process configuration system defines the process action based on the one or more values.

2. The computing system of claim 1, and further comprising an application programming interface (API) set, wherein the process action calls at least one API in the API set.

3. The computing system of claim 2, wherein the process configuration system accesses API metadata to identify the set of parameters.

4. The computing system of claim 1, wherein the set of parameters comprises at least one of an input parameter that is passed to the programming interface or an output parameter that is returned from the programming interface.

5. The computing system of claim 4, wherein the process configuration system is configured to identify a parameter constraint relative to the set of parameters, the parameter constraint comprising at least one of a range of allowable values for a given parameter or a value type for a given parameter.

6. The computing system of claim 5, wherein the process configuration system is configured to constrain the one or more values for the set of parameters based on the parameter constraint.

7. The computing system of claim 1, wherein the process configuration system detects a user interaction that defines a set of process action steps for the process action, each process action step targeting at least one programming interface.

8. The computing system of claim 7, wherein, for each process action step, the process configuration system is configured to identify a parameter for the corresponding programming interface targeted by the process action step.

9. The computing system of claim 8, wherein the display system controller is configured to control the display system to generate the process action configuration user interface display with user input mechanisms that prompt the user based on the identified parameter for each process action step.

10. The computing system of claim 7, wherein the process configuration system is configured to generate a library that includes the set of process action steps and is callable from a process to execute the process action steps.

11. The computing system of claim 1, wherein the process configuration system is configured to control the display system to generate a process generation user interface display with user input mechanisms and to detect a user interaction that defines a given process and maps the process action to at least one step in the given process.

12. The computing system of claim 11, wherein the at least one step in the given process calls the process action to execute the process action steps.

13. The computing system of claim 11, wherein the given process comprises at least one of a workflow or a dialog.

14. The computing system of claim 11, wherein the process action is reusable across a plurality of different processes, the process configuration system being configured to detect a user interaction that defines a second process, that is different than the given process, and maps the process action to at least one step in the second process.

15. The computing system of claim 11, wherein the process configuration system detects a user interaction that modifies the process action independent of the given process to which the process action is mapped.

16. The computing system of claim 11, and further comprising:
a process orchestration engine configured to execute the given process such that the at least one step in the given process calls the programming interface.

17. A computing system comprising:
a display system;
a display system controller configured to control the display system to generate a process generation user interface display with user input mechanisms and to detect a user interaction with the user input mechanisms that defines a set of steps for a given process and maps an application programming interface (API) action to at least one of the steps; and
a process generation system configured to generate the given process with the API action.

18. The computing system of claim 17, and further comprising a process action store that stores a set of process actions, each process action targeting at least one API, and wherein the display system controller controls the display system to display an indication of the set of process actions and to detect a user input that maps a given one of the process actions to the at least one step in the given process.

19. The computing system of claim 18, wherein the given process action is reusable across a plurality of different processes, the process generation system being configured to generate a second process having at least one step to which the given process action is mapped.

20. A computing-implemented method comprising:
detecting a user interaction to define a process action that targets at least one programming interface;
identifying a set of parameters for the programming interface;
prompting the user for a parameter value user input based on the set of parameters;
detecting a user interaction that defines at least one parameter value for the set of parameters;
storing the process action with the defined parameter value; and
detecting a user interaction that defines a set of process steps within a process and that maps the process action to at least one of the process steps.
